(19) United States
(12) Patent Application Publication
(10) Pub. No.: US 2026/0010788 A1
(43) Pub. Date: Jan. 8, 2026

(54) MACHINE LEARNING APPARATUS, ELECTRONIC DEVICE, MACHINE LEARNING PROGRAM, AND SIMULATION APPARATUS

(71) Applicant: ROHM CO., LTD., Kyoto-shi (JP)

(72) Inventor: Kenji HAMACHI, Kyoto-shi (JP)

(21) Appl. No.: 19/249,033

(22) Filed: Jun. 25, 2025

(30) Foreign Application Priority Data
Jul. 3, 2024 (JP) 2024-107463

(51) Int. Cl. G06N 3/08; G06N 3/04

(52) U.S. Cl. CPC G06N 3/08; G06N 3/04

(57) ABSTRACT

A machine learning apparatus includes: a model holder that holds a machine learning model; and a computing unit. The computing unit is configured to: input the input data to the machine learning model and perform inference to calculate a first computation result; input, out of the first computation result, output data contained in the output layer to the machine learning model and perform inference to calculate a second computation result; and calculate a middle-layer error according to a loss function based on a first middle-layer anomaly level calculated based on, out of the first computation result, data contained in the middle layer and a second middle-layer anomaly level calculated based on, out of the second computation result, data contained in the middle layer.

### CROSS REFERENCE TO RELATED APPLICATIONS

The present invention claims priority under 35 U.S.C. § 119 to Japanese Patent Application No. 2024-107463 filed on Jul. 3, 2024, the entire contents of which are hereby incorporated by reference.

### BACKGROUND OF THE INVENTION

### 1. Field of the Invention

The present disclosure relates to a machine learning apparatus, an electronic device, a machine learning program, and a simulation apparatus.

### 2. Description of Related Art

Today, AI (artificial intelligence) is increasingly employed in condition-based maintenance of a mechanical system for the maintenance of factory equipment in industrial fields.

### SUMMARY OF THE INVENTION

According to one aspect of the present disclosure, a machine learning apparatus includes a model holder and a computing unit. The model holder is configured to hold a machine learning model that includes an input layer, an output layer, and at least one middle layer between the input and output layers. The computing unit is configured to: input the input data to the machine learning model and perform inference to calculate a first computation result; input, out of the first computation result, output data contained in the output layer to the machine learning model and perform inference to calculate a second computation result; and calculate a middle-layer error according to a loss function based on a first middle-layer anomaly level calculated based on, out of the first computation result, data contained in the middle layer and a second middle-layer anomaly level calculated based on, out of the second computation result, data contained in the middle layer.

According to another aspect of the present disclosure, an electronic device includes the machine learning apparatus configured as described above.

According to yet another aspect of the present disclosure, a machine learning program makes a computer function as the machine learning apparatus configured as described above.

According to still another aspect of the present disclosure, a simulation apparatus calculates a middle-layer error using the machine learning apparatus configured as described above.

According to a further aspect of the present disclosure, a method for anomaly detection uses a machine learning apparatus including: a model holder configured to hold a machine learning model including an input layer, an output layer, and at least one middle layer between the input and output layers; and a computing unit configured to: input predetermined input data to the machine learning model and perform inference to calculate a computation result; and calculate a middle-layer error based on a plurality of computation results. The method for anomaly detection includes: a step of inputting first input data as the input data to the machine learning model and performing inference to calculate as a computation result a first computation result; a step of inputting, out of the first computation result, output data contained in the output layer to the machine learning model and performing inference to calculate as a computation result a second computation result; and a step of calculating the middle-layer error based on, out of the first computation result, data contained in the middle layer and, out of the second computation result, data contained in the middle layer.

### BRIEF DESCRIPTION OF THE DRAWINGS

FIG. 1 is a diagram showing a configuration of a computer.

FIG. 2 is a block diagram showing a configuration of a machine learning apparatus according to a first embodiment of the present disclosure.

FIG. 3 is a diagram showing a configuration of a machine learning model.

FIG. 4 is a diagram schematically showing how an input-output error and a second hidden-layer error are generated using input data and a machine learning model.

FIG. 5 is a graph showing one example of input data.

FIG. 6 is a graph showing part of FIG. 5 on an enlarged scale.

FIG. 7 is a graph showing part of FIG. 5 on an enlarged scale.

FIG. 8 is a graph showing calculation results of an input-output error, a first hidden-layer anomaly level, and a second hidden-layer anomaly level as observed when input data is input to a machine learning model.

FIG. 9 is a graph showing calculation results of an input-output error, a first hidden-layer anomaly level, and a second hidden-layer anomaly level as observed when input data other than the input data shown in FIG. 5 and FIG. 8 is input to a machine learning model.

FIG. 10 is a graph showing calculation results of an input-output error, a first hidden-layer anomaly level, and a second hidden-layer anomaly level as observed when input data other than the input data shown in FIG. 5, FIG. 8, and FIG. 9 is input to a machine learning model.

FIG. 11 is a graph showing calculation results of an input-output error, a first hidden-layer anomaly level, and a second hidden-layer anomaly level as observed when, as input data, simulation data is input to a machine learning model.

FIG. 12 is a flow chart of a method for anomaly detection using a machine learning apparatus.

FIG. 13 is a flow chart showing details of a first computation step.

FIG. 14 is a flow chart showing details of a second computation step.

FIG. 15 is a flow chart showing details of a third computation step.

FIG. 16 is a diagram schematically showing how an input-output error, a first hidden-layer anomaly level, a first hidden-layer error, and a second hidden-layer error are calculated in a machine learning apparatus according to a second embodiment.

### DETAILED DESCRIPTION OF PREFERRED EMBODIMENTS

### <Computer>

First, a description will be given of a computer 100 that functions as a machine learning apparatus 6 according to the present disclosure. After that, the machine learning apparatus 6 according to a first embodiment of the present disclosure will be described in detail.

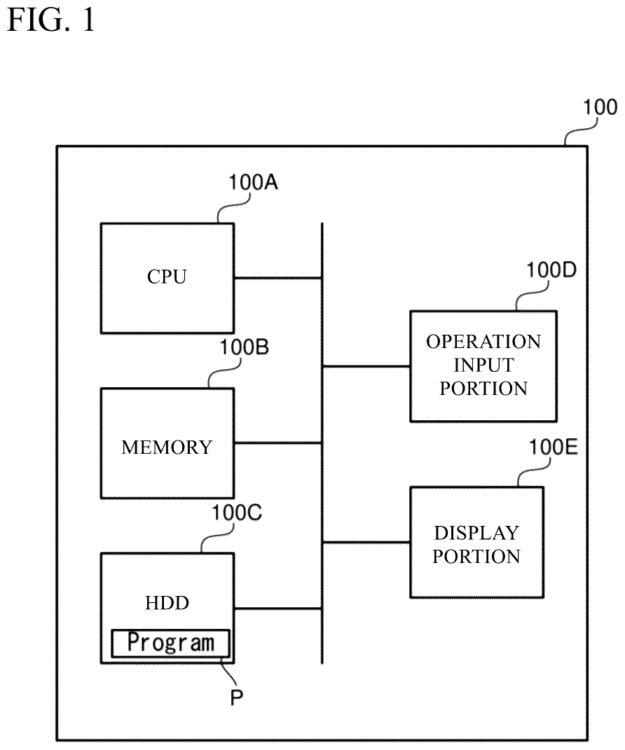

FIG. 1 is a diagram showing the configuration of the computer 100. The computer 100 functions as the machine learning apparatus 6 described later. The computer 100 is, for example, a PC (personal computer).

The computer 100 includes a CPU (central processing unit) 100A, a memory 100B, an auxiliary storage device 100C, an operation input portion 100D, and a display portion 100E.

The CPU 100A includes a control device and a computation device (neither is shown). The control device interprets instructions in a program to control the different parts of the computer 100. The computation device executes arithmetic operations.

The memory 100B is a semiconductor storage device that temporarily stores data. The information stored in the memory 100B is lost when the power to the computer 100 is turned off.

The auxiliary storage device 100C is configured with an HDD (hard disk drive), an SSD (solid-state drive), or the like and stores a program or data. The program stored in the auxiliary storage device 100C is read into the memory 100B. The CPU 100A executes the program read into the memory 100B.

Here, the auxiliary storage device 100C has a simulation program P stored in it. The simulation program P is a program that makes the computer 100 function as the machine learning apparatus 6 described later. The machine learning apparatus 6 will be described in detail later.

The operation input portion 100D is configured with a keyboard, a mouse, and the like and feeds the computer 100 with the input of user operations. The information input through the operation input portion 100D is fed to the memory 100B.

The display portion 100E is configured with, for example, a liquid crystal display and outputs the information acquired from the memory 100B in a form converted into an image.

### <Machine Learning Apparatus 6 of a First Embodiment>

Next, a machine learning apparatus 6 according to a first embodiment of the present disclosure will be described. The machine learning apparatus 6 is configured with an MCU (microcontroller unit). The machine learning apparatus 6 is incorporated in a mechanical system (such as a motor device) to control it. The machine learning apparatus 6 can, in addition to controlling the mechanical system, perform machine learning using as input data various kinds of data on the mechanical system.

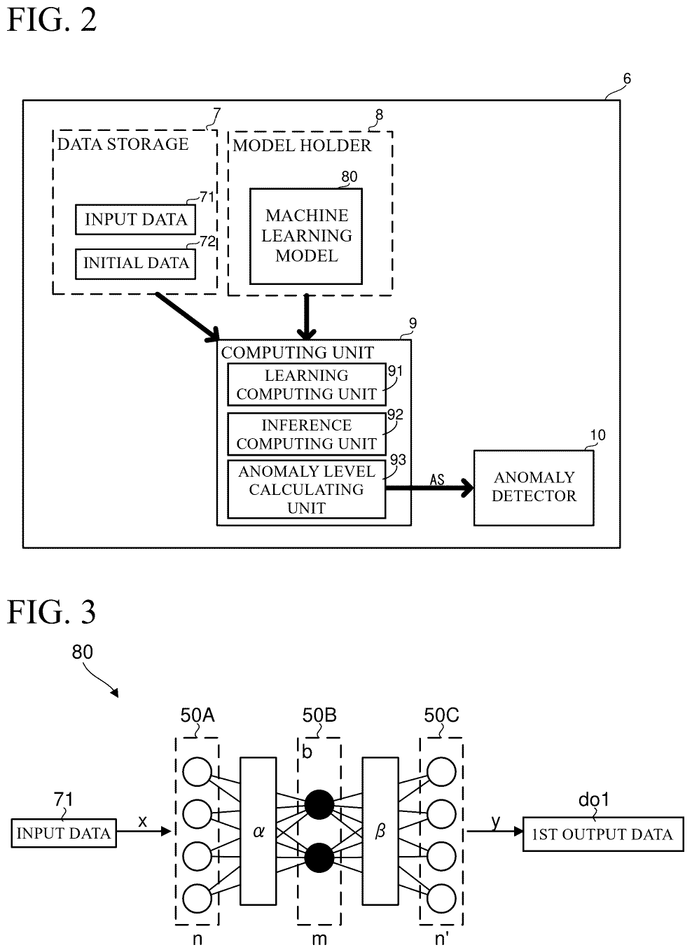

FIG. 2 is a block diagram showing the configuration of the machine learning apparatus 6 according to the first embodiment of the present disclosure. As shown in FIG. 2, the machine learning apparatus 6 includes a data storage 7, a model holder 8, a computing unit 9, and an anomaly detector 10.

The data storage 7 stores input data 71 and initial data 72. The input data 71 is, for example, time-series data output from the mechanical system or the like. As necessary, this time-series data can be subjected to preprocessing such as normalization or FFT. In the initial data 72, as mentioned above, initial values determined by the computer 100 are set.

The model holder 8 holds a machine learning model 80. The machine learning model 80 is one that can learn and infer based on the input data. The machine learning model 80 will be described in detail later.

Using the input data 71 and the machine learning model 80, the computing unit 9 calculates a first computation result 30. The first computation result 30 includes first output data do1, an input-output error da1, a first hidden-layer vector ha, and a first hidden-layer anomaly level da2, which will be described later. Using the first output data do1 and the machine learning model 80, the computing unit 9 calculates a second computation result 31. More specifically, the computing unit 9 is configured as follows.

The computing unit 9 includes a learning computing unit 91, an inference computing unit 92, and an anomaly level calculating unit 93. The learning computing unit 91 performs unsupervised learning using the machine learning model 80, the input data 71, and the initial data 72.

The inference computing unit 92 performs inference using the machine learning model 80, the input data 71, and the initial data 72. Inference can be performed during the above-mentioned learning by the learning computing unit 91 and after completion of the learning.

The anomaly level calculating unit 93 calculates, using the input data 71 and the machine learning model 80, the input-output error da1, the first hidden-layer anomaly level da2, a second hidden-layer anomaly level db1, and a second hidden-layer error da4. The anomaly level calculating unit 93 transmits the so calculated input-output error da1, first hidden-layer anomaly level da2, second hidden-layer anomaly level db1, and second hidden-layer error da4 as a calculation result AS to the anomaly detector 10.

The input-output error da1 is an error, as observed when the input data 71 is input to the machine learning model 80 and inference is performed, between the values contained in an input layer 50A (i.e., the input data 71) and the values contained in an output layer 50C (i.e., the first output data do1), and is calculated according to a loss function, which will be described later.

The second hidden-layer error da4 is an error between the first hidden-layer anomaly level da2, which will be described later, and the second hidden-layer anomaly level db1, which too will be described later, and is calculated according to a loss function, which will be described later.

The first hidden-layer anomaly level da2 represents a normalized distance between the first hidden-layer vector ha and the mean vector of the first hidden-layer vector ha. The first hidden-layer vector ha is a feature vector that indicates the feature of a hidden layer 50B as observed when inference is performed with the input data 71 input to the machine learning model 80.

The second hidden-layer anomaly level db1 represents a normalized distance between the second hidden-layer vector hb and the mean vector of the second hidden-layer vector hb. The second hidden-layer vector hb is a feature vector of the hidden layer 50B as observed when inference is performed with the first output data do1 input to the machine learning model 80.

With time-series data in which the input data 71 recurs at a predetermined cycle, if a change appears in the tendency of the recurring data, a change is likely to occur also in each of the input-output error da1, the first hidden-layer anomaly level da2, the second hidden-layer anomaly level db1, and the second hidden-layer error da4. Here, the input-output error da1, the first hidden-layer anomaly level da2, the second hidden-layer anomaly level db1, and the second hidden-layer error da4 can exhibit different tendencies or similar tendencies. The method for calculating each of the input-output error da1, the first hidden-layer anomaly level da2, the second hidden-layer anomaly level db1, and the second hidden-layer error da4 is calculated will be described in detail later.

The anomaly detector 10 receives the calculation result AS from the anomaly level calculating unit 93 and, based on the data contained in the calculation result AS, checks for an anomaly in the input data 71. Specifically, referring to the tendency of each of the input-output error da1, the first hidden-layer anomaly level da2, and the second hidden-layer error da4, the anomaly detector 10 checks for a change in data tendency with the passage of time and, if it finds one, the anomaly detector 10 recognizes an anomaly. The anomaly detector 10 outputs the detection result externally. In a case where a computer 100 is made to function as the machine learning apparatus 6 as described above, the anomaly detector 10 outputs the detection result to the display portion 100E.

Next, the machine learning model 80 will be described in detail. FIG. 3 is a diagram showing the configuration of the machine learning model 80. The machine learning model 80 is an inference model that can learn using predetermined learning data. As shown in FIG. 3, the machine learning model 80 has a three-layer neural network 50.

The three-layer neural network 50 is an AI model that has an input layer 50A, a hidden layer 50B, and an output layer 50C. The hidden layer 50B is also called a middle layer. In general, with a three-layer neural network 50, for n-dimensional input data of batch size k, x∈Rk×n, the n′-dimensional inference result y∈Rk×n′ is obtained as y=G(x·α+b)β. Here, α∈Rn×m is the weight with which the input layer 50A and the hidden layer 50B are coupled; β∈Rm×n′ is the weight with which the hidden layer 50B and the output layer 50C are coupled. On the other hand, b∈Rm is the bias for the hidden layer 50B; G is the activating function for the hidden layer 50B. Usable as the activation function is, for example, a sigmoid, ReLU, or other function.

The three-layer neural network 50 employs an algorithm that can learn progressively by a desired batch size at a time. When the machine learning data of batch size kᵢ, {xᵢ∈Rkᵢ×n, tᵢ ∈Rkᵢ×n′} is obtained, it is necessary to determine Bi that minimizes the error given by Expression (1) below.

$$‖ [ \begin{matrix}{H}_{0} \\ ⋮ \\ {H}_{i}\end{matrix} ] {β}_{i} - [ \begin{matrix}{t}_{0} \\ ⋮ \\ {t}_{i}\end{matrix} ] ‖ \qquad ( 1 )$$

Here, the ith hidden-layer matrix is Hᵢ=G(xᵢ·α+b); t is the teaching data for the inference result y.

The optimized weight βᵢ is given by Expression (2) below.

$${P}_{i} = {P}_{i - 1} - {P}_{i - 1} {{H}_{i}^{T} ( I + {H}_{i} {P}_{i - 1} {H}_{i}^{T} )}^{- 1} {H}_{i} {P}_{i - 1} \qquad ( 2 )$$

$${β}_{i} = {β}_{i - 1} + {P}_{i} {H}_{i}^{T} ( {t}_{i} - {H}_{i} {β}_{i - 1} )$$

Here, P₀ and β₀ are given by Expression (3) below.

$${P}_{0} = {( {H}_{0}^{T} {H}_{0} )}^{- 1} \qquad ( 3 )$$

$${β}_{0} = {P}_{0} {H}_{0}^{T} {t}_{0}$$

The algorithm of learning is as follows:
(1) Initialize the weight α and the bias β with a random number.
(2) Calculate H₀ for x₀ and calculate P₀ and β₀.
(3) Every time the ith learning data of batch size k; is obtained, calculate Pᵢ and βᵢ. Here, B₀ need not be calculated according to the equation for its calculation in Expression (3); instead, a value initialized with a random number can be taken as β₀.

The bottleneck in Expression (2) above in terms of the amount of computation is (I+HᵢPᵢ₋₁Hᵢ^{T})⁻¹; here, the matrix size of (I+HᵢPᵢ₋₁Hᵢ^{T})⁻¹ is k×k, so if k=1, inverse matrix computation can be replaced with reciprocal computations. Accordingly, keeping the batch size k=1 allows easy computation even for a computation device like a microprocessor.

Moreover, in this embodiment, the machine learning model 80 learns using an autoencoder. An autoencoder uses input data as it is as teaching data, and learns in a way that the input data can be reconstructed as an inference result; that is, in terms of what has been described above, it learns assuming that t=x. An autoencoder does not require separately created teaching data and is therefore one kind of uninstructed learning algorithm. Moreover, keeping the number of nodes in a hidden layer smaller than the number of nodes in the input and output layers makes it possible, if the error between the input data and the inference result converges, to regard the hidden-layer matrix as a compressed dimension form of the input data. That is, input data x yields an encoded result H=G(x·γ+b) and H yields a decoded result y=H·τ.

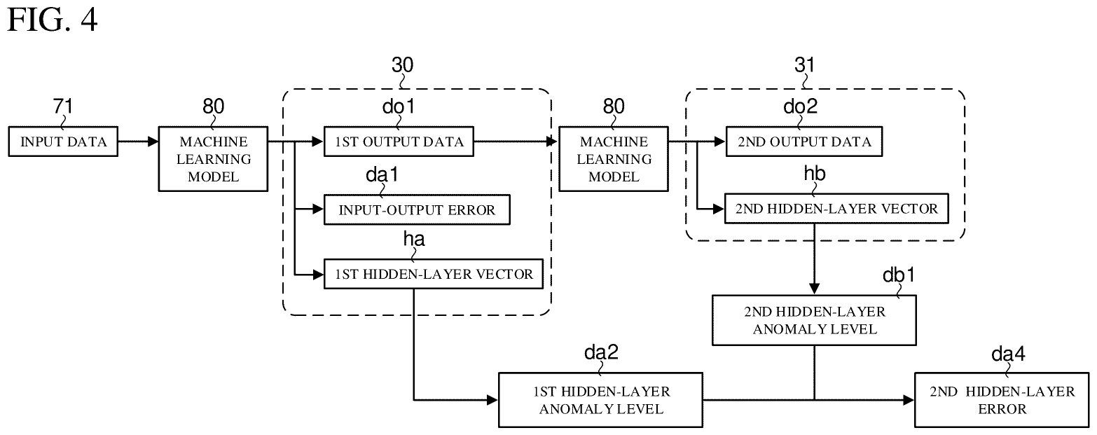

FIG. 4 is a diagram schematically showing how, using the input data 71 and the machine learning model 80, the input-output error da1 and the second hidden-layer error da4 are generated.

As show in FIG. 4, inputting the input data 71 to the machine learning model 80 and performing computation in the computing unit 9 yields the first computation result 30. The first computation result 30 contains first output data do1, an input-output error da1, and a first hidden-layer vector ha. Specifically, this proceeds as follows.

Inputting the input data 71 to the machine learning model 80 and performing inference in the inference computing unit 92 yields the first output data do1 as an inference result. At this time, the anomaly level calculating unit 93 calculates the input-output error da1. Also at this time, the first hidden-layer vector ha is obtained as the feature vector of the hidden layer 50B.

Furthermore, inputting the first output data do1 to the machine learning model 80 and performing computation in the computing unit 9 yields the second computation result 31. The second computation result 31 contains second output data do2 and a second hidden-layer vector. Specifically, this proceeds as follows.

Inputting the first output data do1 to the machine learning model 80 and performing inference in the inference computing unit 92 yields the second output data do2 as an inference result. At this time, the second hidden-layer vector hb is obtained as the feature vector of the hidden layer 50B.

Then the anomaly level calculating unit 93 calculates the first hidden-layer anomaly level da2 and the second hidden-layer anomaly level db1. Based on the first hidden-layer anomaly level da2 and the second hidden-layer anomaly level db1, the anomaly level calculating unit 93 then calculates the second hidden-layer error da4. The methods for calculating these will be described in detail later.

### <Example of Anomaly Detection>

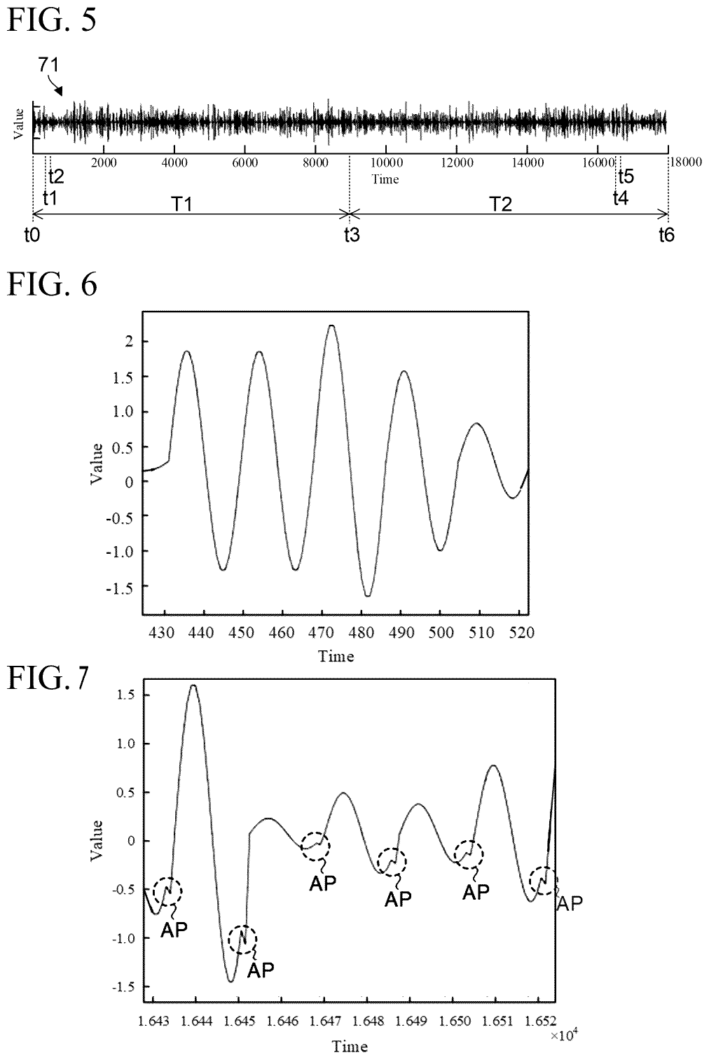

Next, anomaly detection for the input data 71 will be described by way of specific examples. FIG. 5 is a graph showing one example of the input data 71. In FIG. 5, the input data 71 is presented in a time-series graph with time along the horizontal axis and a predetermined output value along the vertical line. FIG. 6 is a graph showing the part of FIG. 5 from time t1 to time t2 on an enlarged scale. FIG. 7 is a graph showing the part of FIG. 5 from time t4 to time t5 on an enlarged scale.

In FIG. 5, the data starts at time to and ends at time t6. In FIG. 5, the period from time t0 to time t3 is a normal period T1. In FIG. 5, the period from time t3 to time t6 is an anomalous period T2.

The normal period T1 is a period in which the input data 71 has no anomaly. That is, the normal period T1 is a period in which the output value of the mechanical system incorporating the machine learning apparatus 6 is estimated to have no particular anomaly. On the other hand, the anomalous period T2 is a period in which the input data 71 has an anomaly. That is, the anomalous period T2 is period in which the output value of the mechanical system incorporating the machine learning apparatus 6 is estimated to have some anomaly.

As shown in FIGS. 5 and 6, the input data 71 in the normal period T1 has a waveform, analogous to a sine wave, that oscillates at a constant cycle. By contrast, as shown in FIG. 5 and FIG. 7, the input data 71 in the anomalous period T2, though having a waveform that oscillates at a constant cycle, exhibits an anomalous part (in the following description, referred to as “anomalous part Ap”) in the latter half of its waveform in each cycle.

However, it is difficult for the user to judge whether the input data 71 has an anomaly with a glance at the input data 71 as presented in FIG. 5. Enlarging the graph of the input data 71 as shown in FIG. 7 may be of some help in making a judgment but doing so can be troublesome.

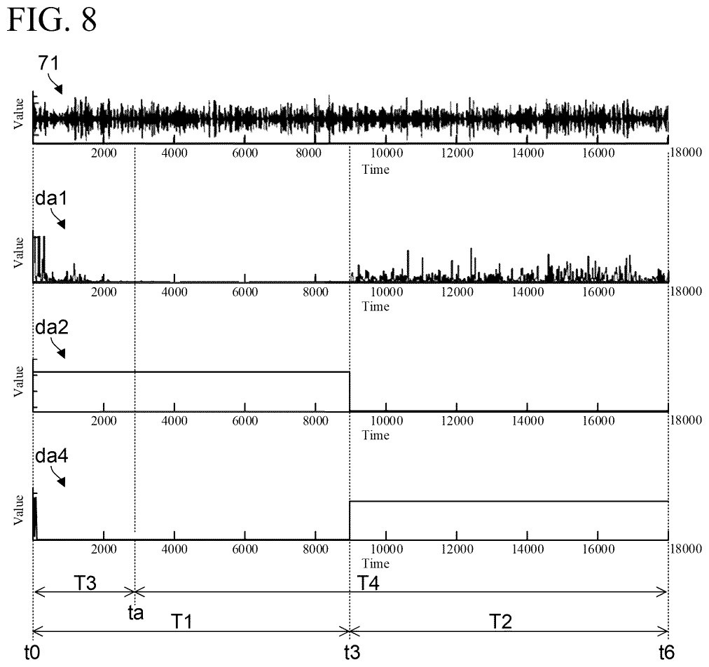

FIG. 8 is a graph showing the results of calculating the input-output error da1, the first hidden-layer anomaly level da2, and the second hidden-layer error da4 as obtained when the input data 71 is input to the machine learning model 80. In FIG. 8, the input-output error da1, the first hidden-layer anomaly level da2, and the second hidden-layer error da4 are presented in a time-series graph with time along the horizontal axis and a predetermined value along the vertical axis.

In FIG. 8, the period from time to t0 time ta is a learning period T3. The learning period T3 is a period in which the input data 71 is input to the machine learning model 80 so that it learns. The period from time ta to time t6 is an inference period T4. The inference period T4 is a period in which the input data 71 is input to the machine learning model 80 so that it infers.

In the learning period T3, among others, features of the input data 71 are acquired; thus the input-output error da1, the first hidden-layer anomaly level da2, and the second hidden-layer error da4 each exhibit a large change in data value (value along the vertical axis). The learning period T3, in which the input-output error da1, the first hidden-layer anomaly level da2, and the second hidden-layer error da4 are unstable by sensitively responding to the change of the input value, is unsuitable for detection of an anomalous value in the input data 71. Accordingly, here, whether the input data 71 has an anomalous value is judged in the inference period T4.

As shown in FIG. 8, in the inference period T4, and more specifically in the normal period T1 in it, the input-output error da1, the first hidden-layer anomaly level da2, and the second hidden-layer error da4 each remain flat, exhibiting no notable change.

On the other hand, in the anomalous period T2, the input-output error da1 exhibits a large change in data tendency as compared with in the normal period T1; specifically, in contrast to in the normal period T1, the data value rises sharply and frequently.

Likewise, in the anomalous period T2, the first hidden-layer anomaly level da2 falls sharply at time t3 and then remains flat at zero. By contrast, in the anomalous period T2, the second hidden-layer error da4 rises sharply at time t3 and then remains flat at about 0.1. From these observations, it can be estimated that, between the normal period T1 and the anomalous period T2, the input data 71 has incurred some change in tendency and hence an anomaly.

On detecting a change in tendency that has occurred in the input-output error da1, the first hidden-layer anomaly level da2, or the second hidden-layer error da4, the anomaly detector 10 outputs a detection result. This can be achieved by, for example, indicating an alert or warning on the display portion 100E.

By recognizing and analyzing the detection result output from the anomaly detector 10, the user can judge whether the input data 71 includes an anomalous value and hence whether the mechanical system or the like incorporating the machine learning apparatus 6 has a fault.

### <Another Example of Anomaly Detection>

Next, anomalous value detection for the input data 71 will be described using another example of data. Here, a motor current will be taken as the input data 71. The following description deals with an example where an anomaly in the motor current is detected to detect damage to the inner ring of the motor.

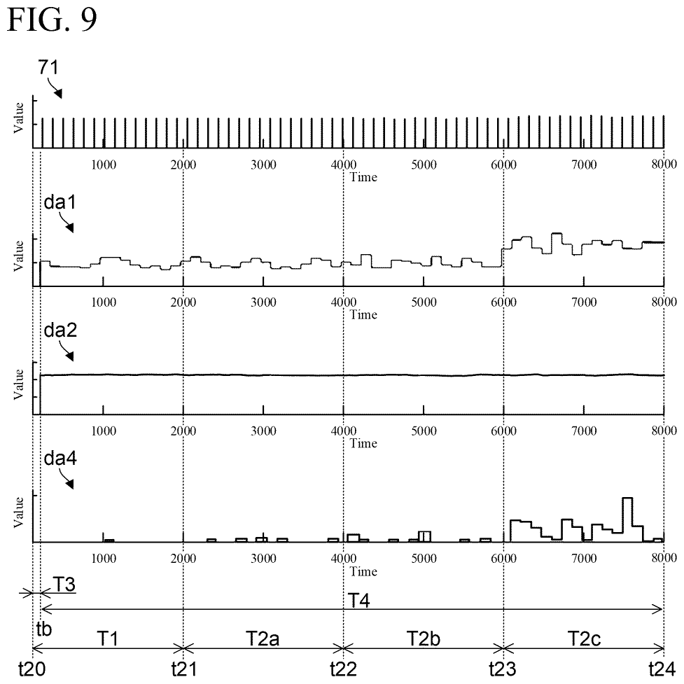

FIG. 9 is a graph showing the results of calculating the input-output error da1, the first hidden-layer anomaly level da2, and the second hidden-layer error da4 when input data 71 different from the input data 71 illustrated as an example in FIG. 5 an FIG. 8 is input to the machine learning model 80.

In FIG. 9, the input data 71, the input-output error da1, the first hidden-layer anomaly level da2, and the second hidden-layer error da4 are presented in a time-series graph with time along the horizontal axis and a predetermined value along the vertical axis.

In FIG. 9, the data starts at time t20 and ends at time t24. The period from time t20 to time t21 is a normal period T1. The period from time t21 to time t22 is an anomalous period T2a. The period from time t22 to time t23 is an anomalous period T2b. The period from time t23 to time t24 is an anomalous period T2c. The anomalous periods T2a to T2c are periods that are similar in significance to the anomalous period T2 described previously. With attention paid to details, however, the anomalies observed in the anomalous periods T2a to T2c differ slightly from each other.

In FIG. 9, the period from time t20 to time tb is a learning period T3; the period from time tb to time t24 is an inference period T4. As in the example described with reference to FIG. 8, also here, whether the input data 71 has an anomaly is judged in the inference period T4.

As shown in FIG. 9, in the inference period T4, and more specifically in the normal period T1 in it, the first hidden-layer anomaly level da2 and the second hidden-layer error da4 each remain flat, exhibiting no notable change. In the same period, the input-output error da1 exhibits small variation.

Subsequently, in the anomalous period T2a, the input-output error da1 exhibits small variation as in the normal period T1, though the cycle of variation can now be said to be somewhat shorter than in the normal period T1. In the anomalous period T2a, the first hidden-layer anomaly level da2 remains flat as in the normal period T1. In the anomalous period T2a, the second hidden-layer error da4 remains flat as in the normal period T1, though with attention paid to details the second hidden-layer error da4 can now be said to exhibit slight variation in data value.

Subsequently, in the anomalous period T2b, the input-output error da1 exhibits small variation as in the normal period T1 and in the anomalous period T2a, though the cycle of variation can now be said to be shorter than in the normal period T1 and than in the anomalous period T2a, and can even be said to be disturbed. In the anomalous period T2b, the first hidden-layer anomaly level da2 remains flat as in the normal period T1 and in the anomalous period T2a. In the anomalous period T2b, the second hidden-layer error da4 exhibits variation in data value as compared with in the normal period T1. In the anomalous period T2b, the second hidden-layer error da4 exhibits a larger variation width than in the anomalous period T2a.

Subsequently, in the anomalous period T2c, the input-output error da1 exhibits an increased data value as compared with in the normal period T1, in the anomalous period T2a and in the anomalous period T2b. More specifically, the data value rises sharply across time t23. Then, between times t23 and t24, the input-output error da1 repeats increasing and decreasing relative to the value of the rising edge at time t23.

In the anomalous period T2c, the first hidden-layer anomaly level da2 remains flat as in the normal period T1, in the anomalous period T2a, and in the anomalous period T2b, though with attention paid to details the data value can be said to exhibit a larger variation width than in the normal period T1, in the anomalous period T2a, and in the anomalous period T2b, or can be said to exhibit slightly disturbed variation in data value.

In the anomalous period T2c, the second hidden-layer error da4 exhibits variation in data value as compared with in the normal period T1. Moreover, in the anomalous period T2b, the second hidden-layer error da4 exhibits a larger variation width than in the anomalous period T2a and than in the anomalous period T2c.

From the above observations, by referring to the input-output error da1 it can be estimated that the input data 71 has an anomaly in the period from time t21 to time t24 (hence the inner ring of the motor is suffering damage). Moreover, with attention paid to details, it can be estimated that, from time t21 to time t24, the anomaly in the input data 71 is changing, that is, the damage to the inner ring of the motor is progressing.

Likewise, by referring to the first hidden-layer anomaly level da2 it can be estimated that the input data 71 has an anomaly (hence the inner ring of the motor is suffering damage) at least in the period from time t23 to time t24.

Likewise, by referring to the second hidden-layer error da4 it can be estimated that the input data 71 has an anomaly (hence the inner ring of the motor is suffering damage) in the period from time t21 to time t24. Moreover, with attention paid to details, it can be estimated that, from time t21 to time t24, the anomaly in the input data 71 is changing, that is, the damage to the inner ring of the motor is progressing.

The anomaly detector 10 can be configured to recognize as an anomaly a slight change as described above (e.g., the change in tendency occurring in the first hidden-layer anomaly level da2 in the period from time t23 to time t24). The anomaly detector 10 can be configured to allow changes in the definitions it uses to judge whether a detection result is anomalous.

In a case where the anomaly detector 10 is not configured to recognize as an anomaly a slight change as described above, if it refers to the input-output error da1 alone, it may fail to recognize as an anomaly a difference in tendency between the normal period T1 and the anomalous periods T2a and T2b. It is then possible that the input data 71 is judged to have no anomaly in the period from time to t0 time t23. The same can happen if it refers to the first hidden-layer anomaly level da2 alone.

However, in the machine learning apparatus 6 according to this embodiment, the anomaly detector 10 refers to each of the input-output error da1, the first hidden-layer anomaly level da2, and the second hidden-layer error da4 to detect a difference in data tendency in each of them. Thus, as compared with a configuration where only some of the calculation results (e.g., the input-output error da1 and the first hidden-layer anomaly level da2) are calculated, it is possible to find an anomaly in the input data 71 accurately.

### <Yet Another Example of Anomaly Detection>

Next, anomalous value detection for the input data 71 will be described by way of yet another example of data. Here, vibration of a motor is taken as the input data 71. The following description deals with an example where a change in motor vibration is detected to detect damage to the inner ring of the motor.

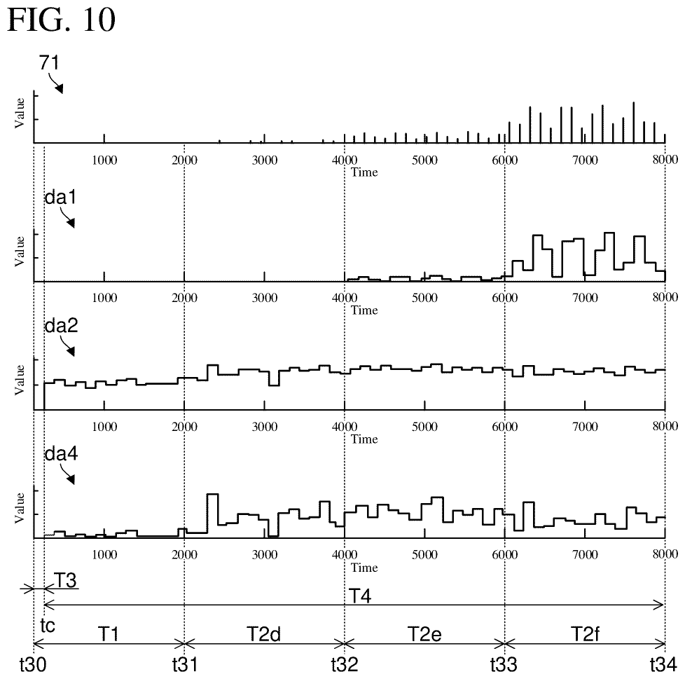

FIG. 10 is a graph showing the results of calculating the input-output error da1, the first hidden-layer anomaly level da2, and the second hidden-layer error da4 as obtained when input data 71 different from the input data 71 illustrated as an example in FIG. 5, FIG. 8, and FIG. 9 is input to the machine learning model 80.

In FIG. 10, the input data 71, the input-output error da1, the first hidden-layer anomaly level da2, and the second hidden-layer error da4 are presented in a time-series graph with time along the horizontal axis and a predetermined value along the vertical axis.

In FIG. 10, the data starts at time t30 and ends at time t34. The period from time t30 to time t31 is a normal period T1. The period from time t31 to time t32 is an anomalous period T2d. The period from time t32 to time t33 is an anomalous period T2e. The period from time t33 to time t34 is an anomalous period T2f. The anomalous periods T2d to T2f are periods that are similar in significance to the anomalous period T2 described previously. More specifically, the anomalous values observed in the anomalous periods T2d to T2f slightly differ from each other as those observed in the anomalous periods T2a to T2c described previously.

In FIG. 10, the period from time t30 to time tc is a learning period T3. The period from time tc to time t34 is an inference period T4. As in the example described with reference to FIG. 8 and FIG. 9, here, whether the input data 71 has an anomaly is checked in the inference period T4.

As shown in FIG. 10, in the inference period T4, and more specifically in the normal period T1 in it, the input-output error da1 remans flat at zero. In the same period, the first hidden-layer anomaly level da2 and the second hidden-layer error da4 each exhibit small variation.

Subsequently, in the anomalous period T2d, the input-output error da1 continues to remain flat as in the normal period T1. In the anomalous period T2d, the first hidden-layer anomaly level da2 exhibits an increase in data value as compared with in the normal period T1. In the anomalous period T2d, the second hidden-layer error da4 exhibits a large increase and decrease in data value as compared with in the normal period T1.

Subsequently, in the anomalous period T2e, the input-output error da1 exhibits small variation as compared with in the normal period T1 and in the anomalous period T2d. In the anomalous period T2e, the first hidden-layer anomaly level da2 is somewhat increased as compared with in the normal period T1 and in the anomalous period T2d and remains flat at the increased value. In the anomalous period T2e, the second hidden-layer error da4 exhibits variation in data value as compared with in the normal period T1. In the anomalous period T2e, the second hidden-layer error da4 exhibits variation not much different from that in the anomalous period T2d. It can however be said that the variation width of the second hidden-layer error da4 there is slightly smaller than in the anomalous period T2d.

Subsequently, in the anomalous period T2f, the input-output error da1 exhibits large variation in data value as compared with in the normal period T1, the anomalous period T2d, and the anomalous period T2e. In the anomalous period T2f, the first hidden-layer anomaly level da2 is similar to, that is, not much different from, as it is in the normal period T1, in the anomalous period T2d, and in the anomalous period T2e.

In the anomalous period T2f, the second hidden-layer error da4 exhibits variation in data value as compared with in the normal period T1. However, the variation that the second hidden-layer error da4 exhibits in the anomalous period T2f is not much different from that in the anomalous period T2e and in the anomalous period T2f. In the anomalous period T2f, however, the variation width of the second hidden-layer error da4 is smaller than that in the anomalous period T2e and in the anomalous period T2f.

From the above observations, it can be said that, by referring to the input-output error da1, it is possible to estimate that, at least in the period from time t32 to time t34, the input data 71 has an anomaly (hence the inner ring of the motor is suffering damage). With attention paid to details, it is possible to estimate that, in the period from time t32 to time t34, the anomaly in the input data 71 changes, that is, the damage to the inner ring of the motor is progressing.

Likewise, it can be said that, by referring to the first hidden-layer anomaly level da2, it is possible to estimate that, in the period from time t3 1 to time t34, the input data 71 has an anomaly (hence the inner ring of the motor is suffering damage). With attention paid to details, it is possible to estimate that, from time t31 to time t32, in the period from time t32 to the; 33, and in the period from time t33 to time t34, the anomaly in the input data 71 changes, that is, the damage to the inner ring of the motor is progressing.

Likewise, it can be said that, by referring to the second hidden-layer error da4, it is possible to estimate that, in the period from time t3 1 to time t34, the input data 71 has an anomaly (hence the inner ring of the motor is suffering damage). With attention paid to details, it is possible to estimate that, in the period from time t31 to time t32, in the period from time t32 to time t33, and in the period from time t33 to time t34, the anomaly in the input data 71 changes, that is, the damage to the inner ring of the motor is progressing.

### <Detecting an Anomaly in Simulation Data>

Next, a description will be given of anomalous value detection for the input data 71 in a case where predetermined simulation data is used as the input data 71.

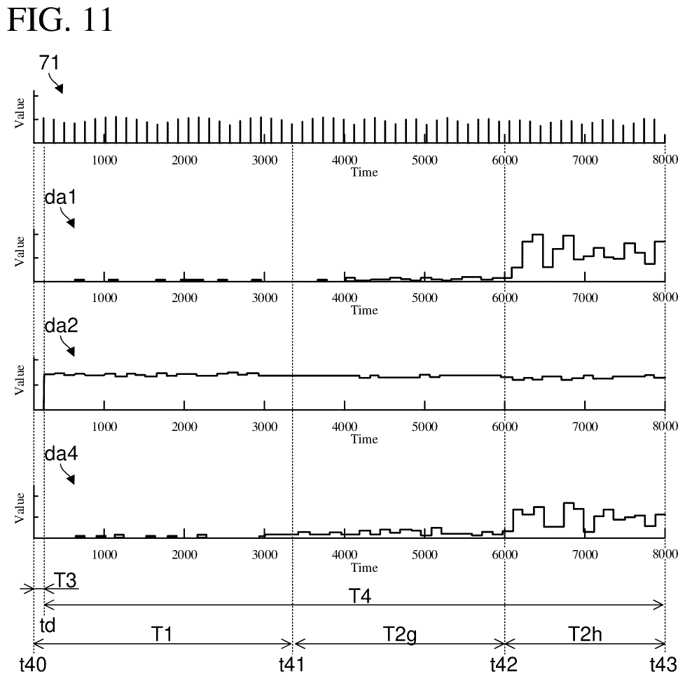

FIG. 11 is a graph showing the results of calculating the input-output error da1, the first hidden-layer anomaly level da2, and the second hidden-layer error da4 as obtained when simulation data as the input data 71 is input to the machine learning model 80.

In FIG. 11, the input data 71, the input-output error da1, the first hidden-layer anomaly level da2, and the second hidden-layer error da4 are represented in a time-series graph with time along the horizontal axis and a predetermined value along the vertical axis.

In FIG. 11, the data starts at time t40 and ends at time t43. The period from time t40 to time t41 is a normal period T1. The period from time t41 to time t42 is a anomalous period T2g. The period from time t42 to time t43 is an anomalous period T2h.

In FIG. 11, the period from time t40 to time td is a learning period T3. The period from time td to time t43 is an inference period T4. As in the example described with reference to FIG. 8 and FIG. 10, here, whether the input data 71 has an anomaly is checked in the inference period T4.

As shown in FIG. 11, in the inference period T4, and more specifically in the normal period T1 in it, the input-output error da1, the first hidden-layer anomaly level da2, and the second hidden-layer error da4 remain flat.

Subsequently, in the anomalous period T2g, the input-output error da1 and the first hidden-layer anomaly level da2 both continue to remain flat as in the normal period T1. In the anomalous period T2g, the second hidden-layer error da4 exhibits variation in data value as compared with in the normal period T1.

Subsequently, in the anomalous period T2h, the input-output error da1 and the second hidden-layer error da4 both exhibit variation in data value as compared with in the normal period T1 and in the anomalous period T2g. With attention paid to details, the first hidden-layer anomaly level da2 exhibits slight variation in data value as compared with in the normal period T1 and in the anomalous period T2g.

From the above observations, by referring to the input-output error da1, it is possible to estimate that, at least in the period from time t42 to time t44, the input data 71 has an anomaly (hence the inner ring of the motor is suffering damage).

Likewise, by referring to the input-output error da2, with attention paid to details, it is possible to estimate that, at least in the period from time t42 to time t44, the input data 71 has an anomaly (hence the inner ring of the motor is suffering damage).

Likewise, by referring to the second hidden-layer error da4, it is possible to estimate that, in the period from time t41 to time t43, the input data 71 has an anomaly (hence the inner ring of the motor is suffering damage). It is also possible to estimate that, between the period from the time t41 to the time t42 and the period from time t42 to time t43, the anomaly in the input data 71 changes, that is, the damage to the inner ring of the motor is progressing.

<Input-Output Error da1>

Now, the method for calculating the input-output error da1 will be described. The input-output error da1 is an error between the second output data do2 and the input data 71 and is calculated according to a loss function, which will be described later. The second output data do2 is the data of the result of inference performed with the first output data do1 input to the machine learning model 80. The input-output error da1 is calculated according to a loss function based on the input data 71 and the second output data do2. Specifically, this proceeds as follows.

Each input value contained in the input data 71 will be referred to as “input value x.” Each output value contained in the second output data do2 (i.e., each value in the inference result) will be referred to as “output value y.” As a loss function for calculating the input-output error da1, it is possible to employ, for example, an MAE (mean absolute error), an MSE (mean squared error) or the like. Here, if the loss function is an MAE, the loss function L is given by Expression (4) below.

$$L ( y , x ) = \frac{1}{{n}^{′}} \sum \vert y - x \vert \qquad ( 4 )$$

If the loss function is an MSE, the loss function L is given by Expression (5) below.

$$L ( y , x ) = \frac{1}{{n}^{′}} \sum {\vert y - x \vert}^{2} \qquad ( 5 )$$

<Second Hidden-Layer Error da4>

Next, the method for calculating the second hidden-layer error da4 will be described. As mentioned above, the second hidden-layer error da4 is an error between the first hidden-layer anomaly level da2 and the second hidden-layer anomaly level db1 and is calculated according to a loss function, which will be described later. First, the first hidden-layer anomaly level da2 and the second hidden-layer anomaly level db1 will be described, followed by a description of the second hidden-layer error da4.

As mentioned earlier, the first hidden-layer anomaly level da2 represents the normalized distance between the first hidden-layer vector ha and the mean vector of the first hidden-layer vector ha. The first hidden-layer vector ha is given by Expression (6) below.

$${h}_{a} = ( \begin{matrix}{h}_{a 1} \\ {h}_{a 2} \\ ⋮ \\ {h}_{am}\end{matrix} ) \qquad ( 6 )$$

The mean vector of the first hidden-layer vector ha is given by Expressions (7) and (8) below.

$$\overline{{h}_{a}} ≡ \frac{1}{m} {\sum }_{i = 1}^{m} {h}_{ai} \qquad ( 7 )$$

$$\overline{{h}_{a}} ≡ ( \begin{matrix}\overline{{h}_{a 1}} \\ \overline{{h}_{a 2}} \\ ⋮ \\ \overline{{h}_{am}}\end{matrix} ) \qquad ( 8 )$$

The first hidden-layer anomaly level da2 is given by Expression (9) below.

$$da {2}^{2} ≡ {( {h}_{a} \to \overline{{h}_{a}} )}^{2} {( \frac{1}{m - 1} {h}_{a} {h}_{a}^{t} )}^{- 1} ( {h}_{a} - \overline{{h}_{a}} ) \qquad ( 9 )$$

As mentioned earlier, the second hidden-layer anomaly level db1 represents the normalized distance between the second hidden-layer vector hb and the mean vector of the second hidden-layer vector hb. The second hidden-layer vector hb is given by Expression (10) below.

$${h}_{b} = ( \begin{matrix}{h}_{b 1} \\ {h}_{b 2} \\ ⋮ \\ {h}_{bm}\end{matrix} ) \qquad ( 10 )$$

The mean vector of the second hidden-layer vector hb is given by Expressions (11) and (12) below.

$$\overline{{h}_{b}} ≡ \frac{1}{m} {\sum }_{i = 1}^{m} {h}_{bi} \qquad ( 11 )$$

$$\overline{{h}_{b}} ≡ ( \begin{matrix}\overline{{h}_{b 1}} \\ \overline{{h}_{b 2}} \\ ⋮ \\ \overline{{h}_{bm}}\end{matrix} ) \qquad ( 12 )$$

The second hidden-layer anomaly level db1 is given by Expression (13) below.

$$db {1}^{2} ≡ {( {h}_{b} \to \overline{{h}_{b}} )}^{2} {( \frac{1}{m - 1} {h}_{b} {h}_{b}^{t} )}^{- 1} ( {h}_{b} - \overline{{h}_{b}} ) \qquad ( 13 )$$

The second hidden-layer error da4 is calculated according to a loss function L that represents the error between the first hidden-layer anomaly level da2 and the second hidden-layer anomaly level db1. If the loss function is an MAE, the loss function L is given by Expression (14) below.

$$L ( db 1 , da 2 ) = \frac{1}{{n}^{′}} \sum \vert db 1 - da 2 \vert \qquad ( 14 )$$

If the loss function is an MSE, the loss function is given by Expression (15) below.

$$L ( db 1 , da 2 ) = \frac{1}{n ′} \sum {\vert db 1 - da 2 \vert}^{2} \qquad ( 15 )$$

### <Method for Anomaly Detection>

Next, the method for anomaly detection using the machine learning apparatus 6 will be described.

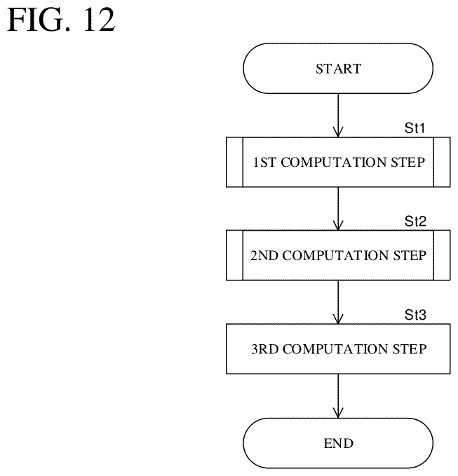

FIG. 12 is a flow chart of a method for anomaly detection using the machine learning apparatus 6. As shown in FIG. 12, first, a first computation step is performed (Step St1). In the first computation step, the input data 71 is input to the machine learning model 80 and inference is performed to calculate the first computation result 30. As described earlier, the first computation result 30 contains first output data do1, an input-output error da1, and a first hidden-layer vector ha.

Next, a second computation step is performed (Step St2). In the second computation step, the first output data do1 is input to the machine learning model 80 and inference is performed to calculate the second computation result 31. As described earlier, the second computation result 31 contains second output data do2 and a second hidden-layer vector hb.

Next, a third computation step is performed (Step St3). In the third computation step, based on the first and second computation results 30 and 31, the second hidden-layer error da4 is calculated. The first to third computation steps (St1 to St3) will now be described in detail one by one.

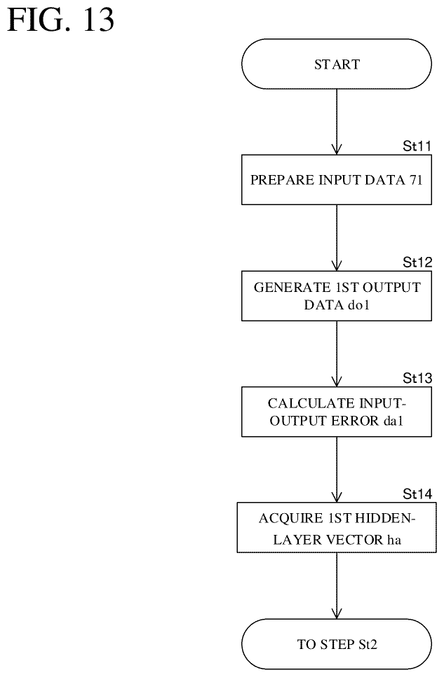

FIG. 13 is a flow chart showing the details of the first computation step. As shown in FIG. 13, first, the user prepares input data 71 (Step St11). Step St11 includes selection and extraction of input data, predetermined preprocessing (such as statistic processing and FFT analysis), and the like.

Next, based on the input data 71 and the machine learning model 80, the inference computing unit 92 performs inference and generates the first output data do1 as the inference result (Step St12). Next, the anomaly level calculating unit 93 calculates the input-output error da1 (Step St13). On the other hand, based on the hidden layer 50B, the anomaly level calculating unit 93 acquires the first hidden-layer vector ha (Step St14). Thus, the first computation step generates as the first computation result 30 the first output data do1, the input-output error da1, and the first hidden-layer vector ha (see FIG. 4). Then a transition is made to the second computation step (Step St2).

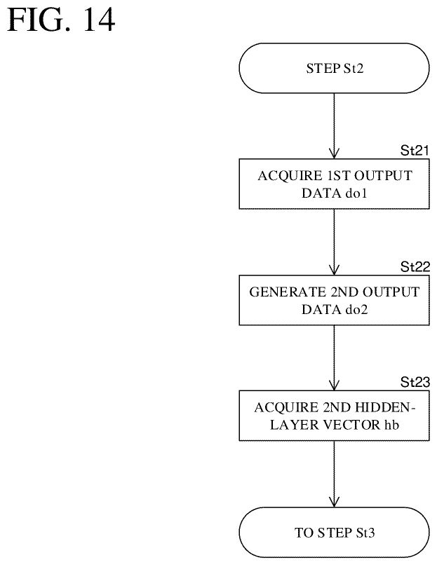

FIG. 14 is a flow chart showing the details of the second computation step. As shown in FIG. 14, in the second computation step, first, the inference computing unit 92 acquires the first output data do1 from the first computation result 30 (Step St21). The first output data do1 is data contained in the output layer 50C of the machine learning model 80 having gone through the first computation step. The acquisition of the first output data do1 can be performed by the inference computing unit 92 or by any other computing unit or can be selected from the first computation result 30 by the user.

Next, the inference computing unit 92 inputs the acquired first output data do1 to the machine learning model 80 and performs inference again, and thereby generates as the inference result the second output data do2 (Step St22). Next, based on the hidden layer 50B, the anomaly level calculating unit 93 acquires the second hidden-layer vector hb (Step St23). Thus, the second computation step generates as the second computation result 31 having gone through the second computation step the second output data do2 and the second hidden-layer vector hb (see FIG. 4). Then a transition is made to the third computation step (Step St3).

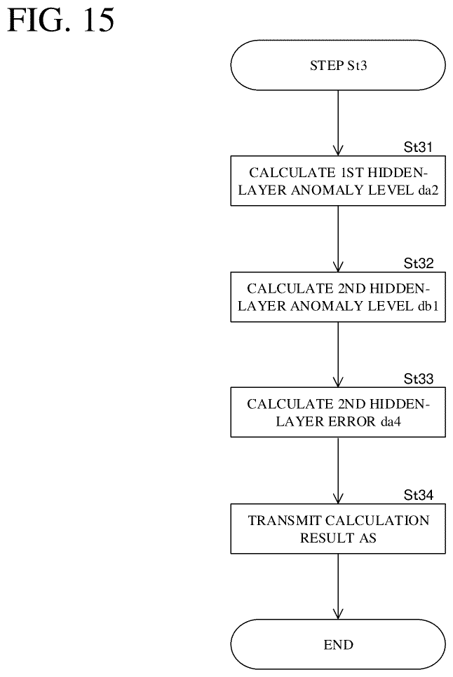

FIG. 15 is a flow chart showing the details of the third computation step. As shown in FIG. 15, in the third computation step, based on the acquired first hidden-layer vector ha, the anomaly level calculating unit 93 calculates the first hidden-layer anomaly level da2 (Step St31). Moreover, based on the acquired second hidden-layer vector hb, the anomaly level calculating unit 93 calculates the second hidden-layer anomaly level db1 (Step St32), Then, using the first and second hidden-layer anomaly levels da2 and db1, the anomaly level calculating unit 93 calculates the second hidden-layer error da4 according to the loss function (Step St33). The anomaly level calculating unit 93 then transmits the calculation result AS to the display portion 100E (Step St34)

### <Machine Learning Apparatus 6 of a Second Embodiment>

Next, a machine learning apparatus 6 according to a second embodiment will be described. The machine learning apparatus 6 of this embodiment shares basically the same configuration with that of the first embodiment described previously. Accordingly, for parts and features common to them, the same reference signs will be adhered to and no overlapping description will be repeated. The following description focuses on differences.

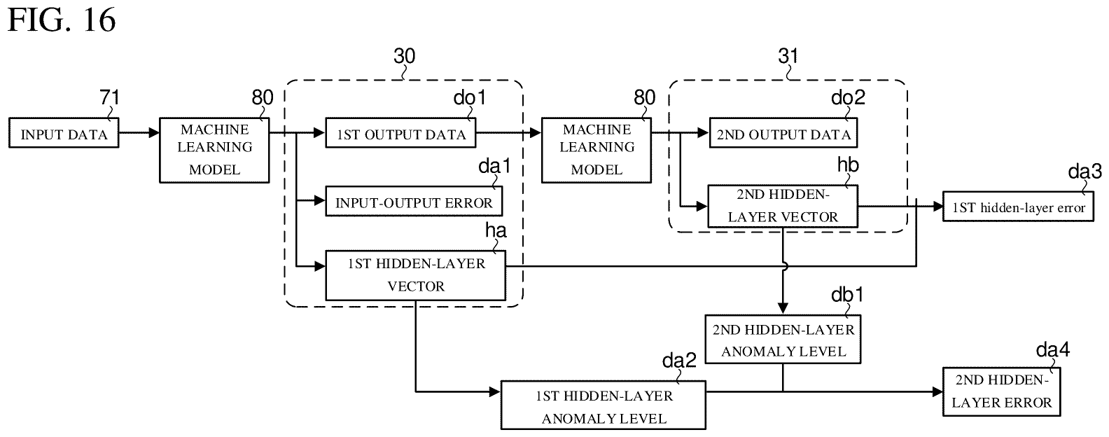

FIG. 16 is a diagram schematically showing how the machine learning apparatus 6 of the second embodiment calculates an input-output error da1, a first hidden-layer anomaly level da2, a first hidden-layer error da3, and a second hidden-layer error da4.

The machine learning apparatus 6 of this embodiment includes a data storage 7, a model holder 8, a computing unit 9, and an anomaly detector 10 similar to those described previously (none is shown). The anomaly level calculating unit 93 calculates the first hidden-layer error da3 based on the first and second hidden-layer vectors ha and hb according to this embodiment (see FIG. 16). The anomaly level calculating unit 93 then transmits as the calculation result AS the calculated first hidden-layer error da3 along with the input-output error da1, the first hidden-layer anomaly level da2, and the second hidden-layer error da4 to the anomaly detector 10. Specifically, the method for calculating the first hidden-layer error da3 is as follows.

<First Hidden-Layer Error da3>

The first hidden-layer error da3 is calculated according to a loss function L that represents the error between the first and second hidden-layer vectors ha and hb. If the loss function is an MAE, the loss function L is given by Expression (16) below.

$$L ( {h}_{b} , {h}_{a} ) = \frac{1}{n ′} \sum \vert {h}_{b} - {h}_{a} \vert \qquad ( 16 )$$

If the loss function is an MSE, the loss function is given by Expression (17) below.

$$L ( {h}_{b} , {h}_{a} ) = \frac{1}{n ′} \sum {\vert {h}_{b} - {h}_{a} \vert}^{2} \qquad ( 17 )$$

Depending on the input data 71, there can be a case where, even through it contains an anomalous value, the input-output error da1 does not exhibit a large change in tendency as discussed previously. Even in such cases, by referring to the first hidden-layer error da3, the user can easily judge whether the input data 71 contains an anomalous value.

As mentioned earlier, the first hidden-layer vector ha is a feature vector that indicates the feature of the hidden layer 50B as observed when inference is performed with the input data 71 input to the machine learning model 80. On the other hand, the second hidden-layer vector hb indicates the feature of the hidden layer 50B as observed when further inference is performed using the inference result (i.e., the first output data do1) based on the input data 71. Thus, the second hidden-layer vector hb is a feature vector that indicates, even if the input data 71 contains an anomalous value, a feature of a “diluted” anomalous value as compared with the first hidden-layer vector ha.

The first hidden-layer error da3 is calculated based on the features of those two hidden layers (first and second hidden-layer vectors ha and hb). This is equivalent to checking for an anomalous value in the input data 71 using two sets of information on the hidden layer 50B that has the features of the input data 71 concentrated in them. Thus, even if only a slight change in tendency is observed in the input-output error da1, the first hidden-layer error da3 may exhibit a marked change. Thus, calculating the first hidden-layer error da3 in addition to the input-output error da1 allows easier detection of an anomalous value in the input data 71/

### <Modifications>

The embodiments described above are not meant to limit the scope of the present disclosure, which can thus be implemented with any modifications made without departure from the spirit of the disclosure. For example, while the first embodiment described above deals with a configuration where the anomaly level calculating unit 93 transmits the calculation result AS (specifically, the input-output error da1, the first hidden-layer anomaly level da2, and the second hidden-layer error da4) to the anomaly detector 10, this is not meant as a limitation. For example, a configuration is also possible where the anomaly level calculating unit 93 transmits the calculation result AS directly to the display portion 100E, or the calculation result is output externally by another means. In such cases, by visually checking the externally output calculation result the user can check for a change in tendency as described above to check for an anomaly in the input data 71.

For another example, while the above description deals with a configuration where the first hidden-layer anomaly level da2 is calculated at Step St31 in the anomaly detection method using the machine learning apparatus 6, this is not meant to limit the timing with which to calculate the first hidden-layer anomaly level da2; the timing can be any timing after Step St13, at which the anomaly level calculating unit 93 acquires the first hidden-layer vector ha, before Step St32, at which it calculates the second hidden-layer error da4.

### <Overview>

According to what is disclosed herein, a machine learning apparatus (6) includes: a model holder (8) configured to hold a machine learning model (80) including an input layer (50A), an output layer (50C), and at least one middle layer (50B) between the input and output layers (50A, 50C); and a computing unit (9) configured to: input the input data (71) to the machine learning model (80) and perform inference to calculate a first computation result (30); input, out of the first computation result (30), output data (do1) contained in the output layer (50C) to the machine learning model (80) and perform inference to calculate a second computation result (31); and calculate a middle-layer error (da4) according to a loss function (L) based on a first middle-layer anomaly level (da2) calculated based on, out of the first computation result (30), data (ha) contained in the middle layer (50B) and a second middle-layer anomaly level (db1) calculated based on, out of the second computation result (31), data (hb) contained in the middle layer (50B). (A first configuration.)

In the machine learning apparatus (6) of the first configuration, the first middle-layer anomaly level (da2) can represent a first normalized distance between a first middle-layer vector (ha), which is a feature vector of the middle layer (50B) obtained as a result of inputting the input data (71) to the machine learning model (80) and performing inference, and a mean vector of the first middle-layer vector (ha). The second middle-layer anomaly level (db1) can represent a second normalized distance between a second middle-layer vector (hb), which is a feature vector of the middle layer (50B) obtained as a result of inputting the output data (do1) to the machine learning model (80), and a mean vector of the second middle-layer vector (hb). (A second configuration.)

In the machine learning apparatus (6) of the second configuration, the first middle-layer vector (ha) can be given by

$${h}_{a} = ( \begin{matrix}{h}_{a 1} \\ {h}_{a 2} \\ ⋮ \\ {h}_{am}\end{matrix} ) ,$$

the mean vector of the first middle-layer (50B) can be given by

$$\overline{{h}_{a}} ≡ ( \begin{matrix}\overline{{h}_{a 1}} \\ \overline{{h}_{a 2}} \\ ⋮ \\ \overline{{h}_{am}}\end{matrix} ) ,$$

the second middle-layer vector (hb) can be given by

$${h}_{b} = ( \begin{matrix}{h}_{b 1} \\ {h}_{b 2} \\ ⋮ \\ {h}_{bm}\end{matrix} ) ,$$

and
the mean vector of the second middle-layer (50B) can be given by

$$\overline{{h}_{b}} ≡ ( \begin{matrix}\overline{{h}_{b 1}} \\ \overline{{h}_{b 2}} \\ ⋮ \\ \overline{{h}_{bm}}\end{matrix} ) .$$

(A third configuration.)

In the machine learning apparatus (6) of the third configuration, the first normalized distance is a distance normalized by use of a covariance matrix given by

(h_{α}h_{α}^{t}), and

the second normalized distance is a distance normalized by use of a covariance matrix given by

(h_{b}h_{b}^{t}). (A fourth configuration.)

In the machine learning apparatus (6) of the fourth configuration, when the first middle-layer anomaly level (da2) is represented by da22, da22 fulfills

$$da {2}^{2} ≡ {( {h}_{a} - \overline{{h}_{a}} )}^{2} {( \frac{1}{m - 1} {h}_{a} {{h}_{a}}^{t} )}^{- 1} ( {h}_{a} - \overline{{h}_{a}} ) ,$$

and
when the second middle-layer anomaly level (db1) is represented by db12, db12 fulfills

$$db {1}^{2} ≡ {( {h}_{b} - \overline{{h}_{b}} )}^{2} {( \frac{1}{m - 1} {h}_{b} {{h}_{b}}^{t} )}^{- 1} ( {h}_{b} - \overline{{h}_{b}} ) .$$

(A fifth configuration.)

According to another aspect of what is disclosed herein, an electronic device (100A) includes the machine learning apparatus (6) of any of the first to fifth configurations. (A sixth configuration.)

According to yet another aspect of what is disclosed herein, a machine learning program (P) makes a computer function as the machine learning apparatus (6) of any of the first to fifth configurations. (A seventh configuration.)

According to still another aspect of what is disclosed herein, a simulation apparatus (100) is configured to calculate the middle-layer error (da4) using the machine learning apparatus (6) of any of the first to fifth configurations. (An eighth configuration.)

According to a further aspect of what is disclosed herein, a method for anomaly detection uses a machine learning apparatus (6) including: a model holder (8) configured to hold a machine learning model (80) including an input layer (50A), an output layer (50C), and at least one middle layer (50B) between the input and output layers (50A, 50C); and a computing unit (9) configured to: input predetermined input data (71) to the machine learning model (80) and perform inference to calculate a computation result (30, 31); and calculate a middle-layer error (da4) based on a plurality of computation results (30, 31). The method includes: a step of inputting first input data (71) as the input data to the machine learning model (80) and performing inference to calculate as the computation result a first computation result (30); a step of inputting, out of the first computation result (30), output data (do1) contained in the output layer (50C) to the machine learning model (80) and performing inference to calculate as the computation result a second computation result (31); and a step of calculating the middle-layer error (da4) based on, out of the first computation result (30), data (ha) contained in the middle layer (50B) and, out of the second computation result (31), data (hb) contained in the middle layer (50B). (A ninth configuration.)

What is claimed is:

1. A machine learning apparatus comprising:
a model holder configured to hold a machine learning model including an input layer, an output layer, and at least one middle layer between the input and output layers; and
a computing unit configured to
input the input data to the machine learning model and perform inference to calculate a first computation result,
input, out of the first computation result, output data contained in the output layer to the machine learning model and perform inference to calculate a second computation result, and
calculate a middle-layer error according to a loss function based on
a first middle-layer anomaly level calculated based on, out of the first computation result, data contained in the middle layer and
a second middle-layer anomaly level calculated based on, out of the second computation result, data contained in the middle layer.

2. The machine learning apparatus according to claim 1, wherein
the first middle-layer anomaly level represents a first normalized distance between a first middle-layer vector, which is a feature vector of the middle layer obtained as a result of inputting the input data to the machine learning model and performing inference, and a mean vector of the first middle-layer vector, and
the second middle-layer anomaly level represents a second normalized distance between a second middle-layer vector, which is a feature vector of the middle layer obtained as a result of inputting the output data to the machine learning model, and a mean vector of the second middle-layer vector.

3. The machine learning apparatus according to claim 2, wherein
the first middle-layer vector is given by
$${h}_{a} = ( \begin{matrix}{h}_{a 1} \\ {h}_{a 2} \\ ⋮ \\ {h}_{am}\end{matrix} ) ,$$
the mean vector of the first middle-layer is given by
$$\overline{{h}_{a}} ≡ ( \begin{matrix}\overline{{h}_{a 1}} \\ \overline{{h}_{a 2}} \\ ⋮ \\ \overline{{h}_{am}}\end{matrix} ) ,$$
the second middle-layer vector is given by
$${h}_{b} = ( \begin{matrix}{h}_{b 1} \\ {h}_{b 2} \\ ⋮ \\ {h}_{bm}\end{matrix} ) ,$$
and
the mean vector of the second middle-layer is given by
$$\overline{{h}_{b}} ≡ ( \begin{matrix}\overline{{h}_{b 1}} \\ \overline{{h}_{b 2}} \\ ⋮ \\ \overline{{h}_{bm}}\end{matrix} ) .$$

4. The machine learning apparatus according to claim 3, wherein
the first normalized distance is a distance normalized by use of a covariance matrix given by
(h_{α}h_{α}^{t}), and
the second normalized distance is a distance normalized by use of a covariance matrix given by
(h_{b}h_{b}^{t}).

5. The machine learning apparatus according to claim 4, wherein
when the first middle-layer anomaly level is represented by da22, da22 fulfills
$$da {2}^{2} ≡ {( {h}_{a} - \overline{{h}_{a}} )}^{2} {( \frac{1}{m - 1} {h}_{a} {{h}_{a}}^{t} )}^{- 1} ( {h}_{a} - \overline{{h}_{a}} ) ,$$
and
when the second middle-layer anomaly level is represented by db12, db12 fulfills
$$db {1}^{2} ≡ {( {h}_{b} - \overline{{h}_{b}} )}^{2} {( \frac{1}{m - 1} {h}_{b} {{h}_{b}}^{t} )}^{- 1} ( {h}_{b} - \overline{{h}_{b}} ) .$$

6. An electronic device comprising the machine learning apparatus according to claim 1.

7. A machine learning program for making a computer function as the machine learning apparatus according to claim 1.

8. A simulation apparatus configured to calculate the middle-layer error using the machine learning apparatus according to claim 1.

9. A method for anomaly detection using a machine learning apparatus including:
a model holder configured to hold a machine learning model including an input layer, an output layer, and at least one middle layer between the input and output layers; and
a computing unit configured to
input predetermined input data to the machine learning model and perform inference to calculate a computation result and
calculate a middle-layer error based on a plurality of the computation results,
the method comprising:
a step of inputting first input data as the input data to the machine learning model and performing inference to calculate as the computation result a first computation result;
a step of inputting, out of the first computation result, output data contained in the output layer to the machine learning model and performing inference to calculate as the computation result a second computation result; and
a step of calculating the middle-layer error based on, out of the first computation result, data contained in the middle layer, and, out of the second computation result, data contained in the middle layer.
